(19) United States
(12) Patent Application Publication
(10) Pub. No.: US 2023/0062035 A1
(43) Pub. Date: Mar. 2, 2023

(54) LIGHTNING PROTECTION SYSTEM

(71) Applicants: Isaac Milton Wostrel-Rubin, Venice, CA (US); Wesley Alexander Evans, Los Angeles, CA (US)

(72) Inventors: Isaac Milton Wostrel-Rubin, Venice, CA (US); Wesley Alexander Evans, Los Angeles, CA (US)

(21) Appl. No.: 17/899,375

(22) Filed: Aug. 30, 2022

Related U.S. Application Data
(60) Provisional application No. 63/238,651, filed on Aug. 30, 2021.

(51) Int. Cl. H02G 13/00

(52) U.S. Cl. CPC H02G 13/80

(57) ABSTRACT

Disclosed is a modular, portable external lightning protection system for protecting objects, persons, and/or animals inside its area. In embodiments, the disclosed system may comprise threaded connections and/or through-hole connections to provide a weld-free system, which requires minimal expertise and time to install. Additionally, the disclosed system may be installed without modification of a protected object.

### RELATED APPLICATION

This application claims benefit to U.S. Provisional Application No. 63/238,651 that was filed on Aug. 30, 2021, which is incorporated by reference herein in its entirety.

### BACKGROUND

The embodiments herein relate generally to lightning protection systems.

Lightning protection systems may sometimes be needed on short notice, and for temporary use. However, conventional systems may require welding, installation of wires, floor plates, roof enclosures, and/or crossbars. This typically necessitates professional installation and renders the system difficult and time consuming to both install and remove. Furthermore, many such systems may require modification of and/or attachment to the object(s) sought to be protected. In such cases, an object which cannot be modified (e.g., due to contract, warranty, or other reason), may be either left unprotected or the user may be forced to breach the agreement. As such, there is a need in the industry for a lightning protection system which addresses the limitations of the prior art.

### SUMMARY

According to various embodiments, disclosed is a modular and portable lightning protection system for protecting persons, animals, and/or objects in an outdoor environment. In certain embodiments, the disclosed system provides a method which may comprise constructing a continuously conductive structure at an outdoor area by connecting a plurality of conductive components. In some embodiments, the continuously conductive structure may comprise: an above ground structure comprising a bottom frame, an upwards extension assembly coupled to the bottom frame, and a grounding assembly coupled to the above ground structure and extending below ground level. In certain embodiments, the continuously conductive structure protects an object, person, and/or animal from a lightning strike within or around the above ground structure. In further embodiments, the plurality of conductive components are connected in a weld-free manner, and the continuously conductive structure can be disassembled and reassembled to various size dimensions.

### BRIEF DESCRIPTION OF THE FIGURES

The detailed description of some embodiments of the invention will be made below with reference to the accompanying figures, wherein the figures disclose one or more embodiments of the present invention.

FIG. 1 is a perspective view of an assembled structure for a lightning protection system, according to certain embodiments.

FIG. 2 is an exploded view of a connection structure for the lightning protection system, the connection structure including a connection block.

FIG. 3 is a perspective view of the connection block.

FIG. 4 is a section view taken along line 4-4 in FIG. 3.

FIG. 5 is a section view taken along line 5-5 in FIG. 3.

FIG. 6 is a section view taken along line 6-6 in FIG. 1.

FIG. 7 is a perspective view of the connection block, shown assembled.

FIG. 8 is a perspective view of an alternate embodiment of the connection structure including an alternate connection block.

FIG. 9 is a perspective view of the alternate connection block.

FIG. 10 is a section view taken along line 10-10 in FIG. 9.

FIG. 11 is a section view taken along line 11-11 in FIG. 9.

### DETAILED DESCRIPTION OF CERTAIN EMBODIMENTS

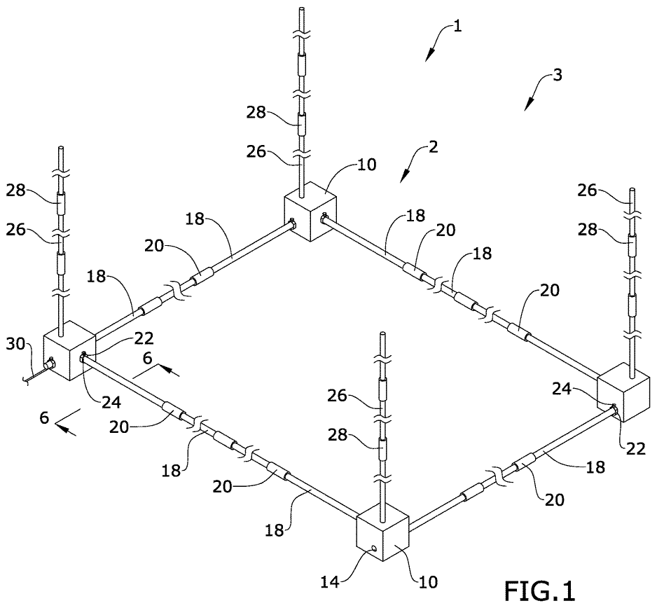

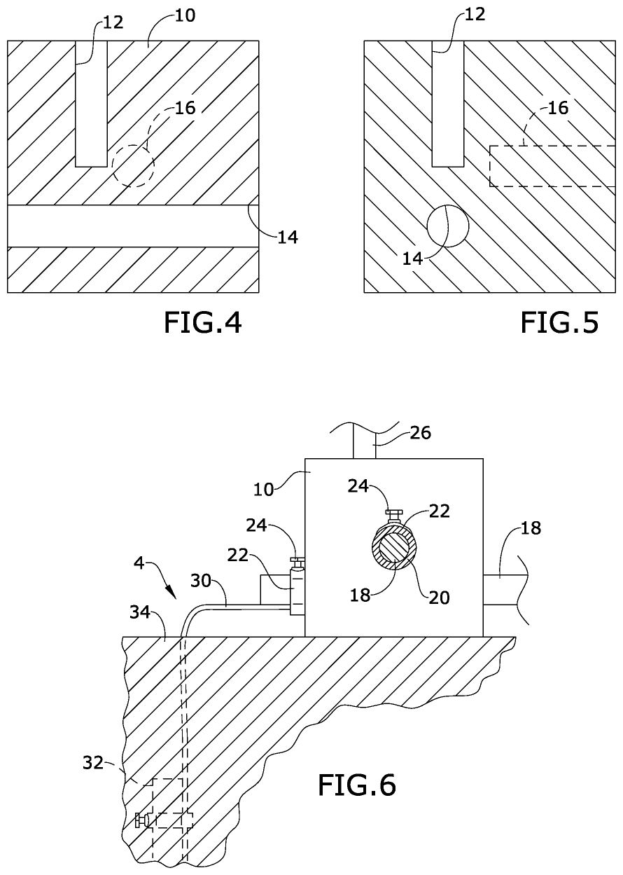

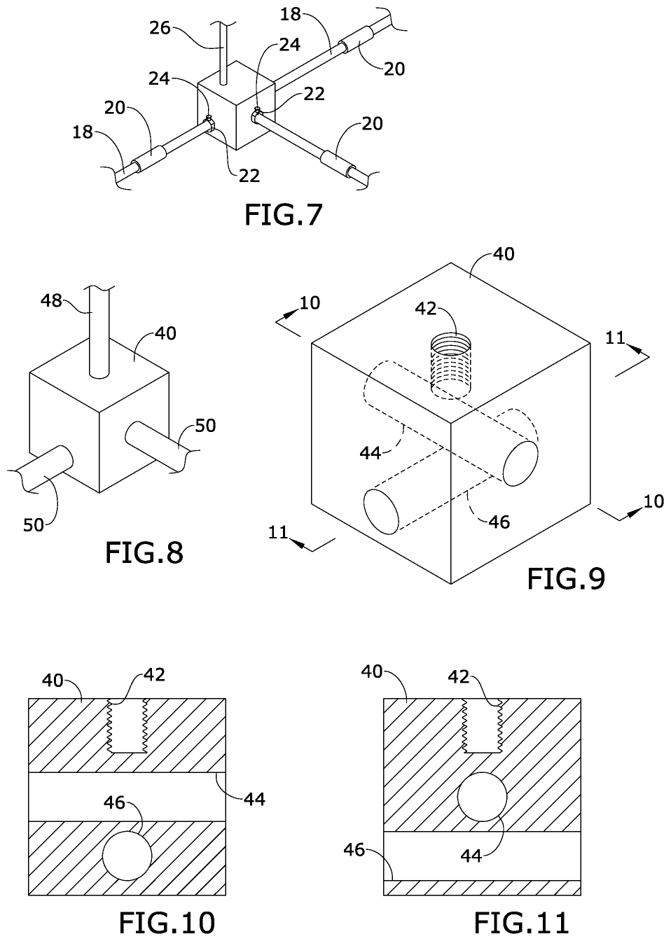

According to various embodiments as depicted in FIGS. 1-11, disclosed is a modular lightning protection system 1. The disclosed system is portable and may be quickly assembled to provide outdoor lightening protection for objects and persons inside its area and/or vicinity.

In embodiments, lightning protection system 1 may comprise an assembly of conductively continuous components, which a user may easily connect to construct a protective frame. The disclosed system may further comprise weld-free connections, such as threaded connections and/or slots or through-hole connections to provide an overall weld-free assembly, which requires minimal expertise and time to install. Furthermore, the lightning protection system may be installed, without modification of the protected object.

In certain embodiments as best depicted in FIG. 1, lightning protection system 1 may generally comprise an above ground conductive modular frame structure 3 and at least one grounding assembly 4 coupled to the frame structure, which may extend from frame structure 3 into the ground 34.

In some embodiments, modular frame structure 3 may generally comprise a bottom frame 2 and an upwards extension structure coupled to the bottom frame. In certain embodiments, the upwards extension structure may include vertical rods 26 (also referred to as terminal extension rods or air terminals) that extend upwards from bottom frame 2. In alternate embodiments, cables (“upwards extension cables”) may be used instead of or in conjunction with the vertical rods to form the upwards extension structure. For example, upward extension cables may be coupled to the top ends of the vertical rods or connection blocks, where high wind conditions may make a rod structure unstable.

Bottom frame 2 may comprise connection blocks 10 and horizontal rods 18 which are connected together to form the bottom frame structure, wherein connection blocks 10 form the corners and horizontal rods 18 form the sides of the bottom frame structure. In some embodiments, a multiple number of horizontal rods 18 may be coupled to one another in succession via horizontal rod couplers 20 to enlarge the area of lightening protection system 1. In alternate embodiments, cables (“bottom frame cables”) may be used instead of or in conjunction with the horizontal rods to form the bottom frame structure. In one example, cables may be coupled between connection blocks where high wind conditions may make a rod structure unstable.

In some embodiments, horizontal rods 18 and vertical rods 26 and/or the upwards extension and bottom frame cables may be made of copper, and connection blocks 10 may be brass. It shall be appreciated, however, that different conductive material(s)/metal(s) may be used in alternate embodiments.

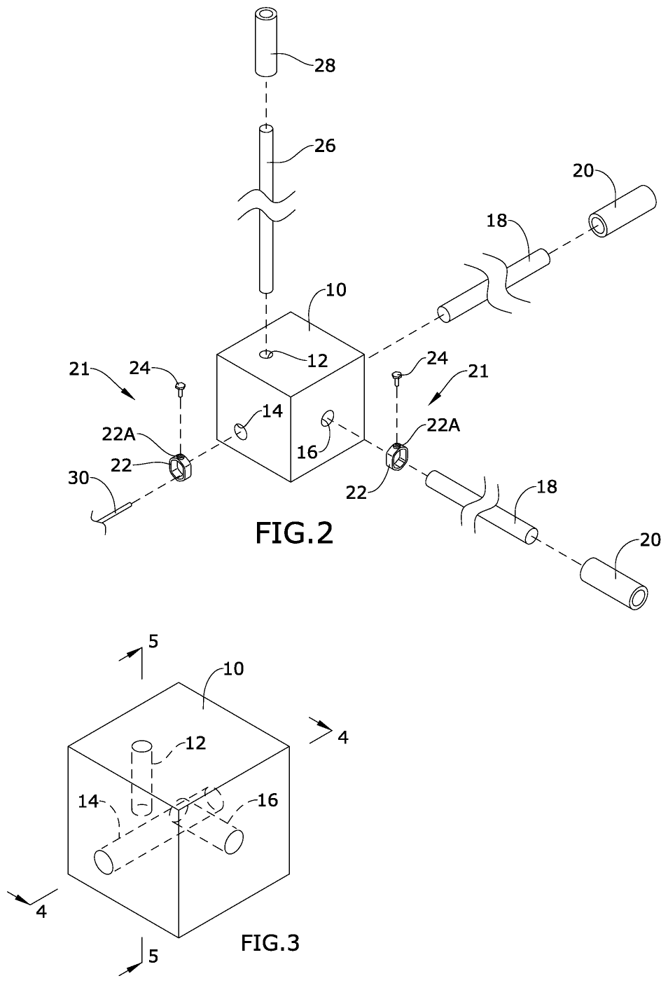

In some embodiments as best depicted in FIGS. 2-5 connection block 10 may be a triple connection cube including a first side opening 14 and a second side opening 16 on adjacent side faces of connection block 10, and a top opening 12 on a top face of connection block 10, wherein openings 14, 16 are configured to receive horizontal rods 18, and top opening 12 is configured to receive vertical rod 26. In one embodiment, first side opening 14 may be a through-hole extending through opposite faces of connection block 10, while second side opening 16 and top opening 12 may be holes which extend partially through connection block 10, as shown in FIGS. 3-5. In some embodiments, firs side opening 14 may be positioned lower than second side opening 16, as shown.

In certain embodiments, each of the end sections of horizontal rods 18 forming the corner-adjacent sides of bottom frame 2 may be inserted through the holes of first side opening 14 or second side opening 16 and is secured with a clamping member 21. Clamping members 21 are configured to clamp the connected horizontal rods 18 in place on the entrance and exit sides of each of the side openings of connection block 10 so as to prevent horizontal rods 18 from shifting and destabilizing the frame. In one embodiment, each clamping member 21 may comprise a coupling ring 22 including a threaded hole 22A, and a coupling ring fastener 24, which may be a screw, configured to threadably engage through threaded hole 22A. In certain embodiments, clamping members 21 may be made of brass or copper. It shall be appreciated that different clamping elements, which may be made of various types of conductive material(s) may be used in alternate embodiments.

In further embodiments, multiple horizontal rods 18 may be coupled to one another in line via horizontal rod couplers 20 to form the sides of bottom frame 2. As such, bottom frame 2 may comprise as many horizontal rods 18 as needed to achieve the desired width and length of the bottom frame, depending on the particular need. In one embodiment, each horizontal rod coupler 20 connecting adjacent horizontal rods 18 may comprise a female-female rod coupler. In certain embodiments, horizontal rod couplers 20 may be brass.

In certain embodiments, vertical rods 26 may be coupled to connection blocks 10 via top opening 12. In some embodiments, a multiple number of vertical rods 26 may be connected in succession via vertical rod couplers 28 to reach a desired or needed height of modular frame structure 3. Additionally, vertical rods 26 acting as air terminals, may be connected at the top of the frame once standard clearance is achieved by lower vertical rods 26 connected to the bottom frame. As such, vertical rods 26 provide air terminals and down conductors with required clearance within modular frame structure 3. In one embodiment, the vertical rods may establish a clearance of at least 2 feet. In some embodiments, vertical rod couplers 28 may be female-female brass rod couplers. It shall be appreciated that different types of rod couplers for the vertical and/or horizontal rods, which may be made of various materials may be used in alternate embodiments. Additionally, couplers may employ threaded connections (wherein the rod ends would be threaded), or friction fit connections, according to various embodiments. In alternate embodiments, connection blocks 10 may be used as intermediate connectors, i.e., for connecting horizontal rods 18 to one another, in alternate embodiments.

In certain embodiments, grounding assembly 4 may comprise a grounding element 32 and a grounding cable 30 which couples grounding element 32 to frame structure 3, and preferably bottom frame 2, wherein grounding element 32 is earthed or grounded at an appropriate earthing site (see FIG. 6). In certain embodiments, grounding element 32 may comprise for example, one or more copper grounding rod(s) and/or lightning plate(s), and grounding cable 30 may be a copper wire. In certain embodiments, grounding cable 30 may be coupled to and held in place by any one of clamping member(s) 21 adjacent opening 14 and/or 16 of connection block 10. In some embodiments, lightning protection system 1 may comprise any number of grounding assemblies 4 necessary for proper grounding. In some embodiments, lighting protection system 1 may comprise one to two grounding assemblies 4. In alternate embodiments, direct contact between bottom frame 2 ground 34 may serve to ground the system; as such, an extraneous grounding component such as grounding assembly 4 may not be necessary. Lightning protection is thus achieved by connecting components of lightning protection system 1 such that they are conductively continuous and grounded.

It shall be appreciated that the disclosed lightning protection system can have multiple configurations, including different types of connection components and connection mechanisms in alternate embodiments. For example, as depicted in FIGS. 8-11, an alternate connection block 40 may comprise a threaded top opening 42, configured to receive an alternate threaded vertical rod 48. In some embodiments, alternate threaded vertical rod 48 may have externally and internally threaded opposite ends, such that successive vertical rods may threadably connect to one another. In further embodiments, threaded top opening 42 may be shorter than top opening 12, which is not threaded, allowing both a first side opening 44 and a second side opening 46 to run entirely through alternate connection block 40 for receiving horizontal rods 50 which are similar to horizontal rods 18. In some embodiments, first side opening 44 and/or second side opening 46 may be unthreaded, as shown in the figures. In alternate embodiments, first side opening 44 and/or second side opening 46 may be threaded, wherein horizontal rods 50 may comprise mating threaded ends.

In certain embodiments, connection blocks 10, 40 may comprise brass cubes. In one embodiment, connection blocks 10, 40 may comprise a cube which is approximately 3×3×3 inches. It shall be appreciated that connection blocks 10, 40 of the disclosed system may be made of different conductive materials and/or of geometric configurations in alternate embodiments.

According to an exemplary embodiment, the disclosed system may be provided as a modular assembly kit comprising the following components: at least 54 copper horizontal rods which may be about ⅝ of an inch in diameter by about 12 inches in length; at least 8 copper vertical rods which may be about ½ inch in diameter by about 48 inches in length; at least 8 female-female brass rod couplers which may be sized and structured to connect the vertical rods at opposite ends of each coupler; at least 50 larger female-female brass rod couplers sized and structured to connect the horizontal rods at opposite ends of each coupler; at least 8 clamping members, which may each comprise a brass or copper coupling ring and fastener, configured to clamp around the horizontal rods; at least 4 brass corner triple connector cubes, which may be about 3 inches×3 inches×3 inches each, and include a threaded top opening configured to receive the vertical rods, and two through hole side openings configured to receive the horizontal rods; at least 2 copper grounding cables; and at least 2 copper grounding rods, which are each at least about ⅜ inches in diameter and 10 ft long. Alternatively, grounding plates may be used depending on terrain and purpose. The 8 clamping members may be attached to the corner adjacent ends of the horizontal rods (2 per each cube), proximate inner and outer adjacent faces of the connector cube.

In embodiments, the disclosed lightning protection system may be assembled around an object and/or area to be protected. Steps for assembling the system may comprise assembling the bottom frame by connecting the horizontal rods to the connection blocks using the necessary number of components including horizontal rod couplers 20 and clamping members; assembling the vertical rods with necessary couplers; and attaching and grounding the grounding assembly components to the bottom frame of the structure. In some embodiments, the copper wire of the grounding assembly may be held in place by the clamping member(s). In some embodiments, assembly of the bottom frame may be a first step; however, the above steps may be carried out according to any order. In certain embodiments the grounding assembly may be omitted if the bottom frame is itself grounded.

The disclosed system provides an assembly of connecting parts forming a lightning protection system kit that is easy to assemble, disassemble, modulate for different objects, and weld-free. The disclosed system may be used to protect various objects, in a manner that does not violate contracts or void warranties, and which may meet applicable lightning protection standards. As one example, the system may be used to protect outdoor generators from lightning strikes (e.g., on film sets) without having to weld various components to the generator, which may violate the rental contract for the generator.

Additionally, the system is portable, and easy to assemble and disassemble, making it ideal for temporary use with the added advantage of being reusable. As the system is modular, it has no set dimension, and can be used for any sized objects. The system may be assembled without welding or complex attachments, and further without components such as a floor plate, roof enclosure, and/or crossbars. Thus, the disclosed system may be assembled by unskilled users, and for a variety of different applications.

It shall be appreciated that the components of the disclosed system described in several embodiments herein may comprise any alternative known materials in the field and may be of any size, shape, and/or dimensions. It shall be appreciated that the components of the disclosed system described herein may be manufactured and assembled using any known techniques in the field.

Additionally, the specific design configuration of the disclosed system may depend on the specific need, and external conditions. For example, in certain cases where the system's frame is directly on top of soil, the grounding/earthing system may be unnecessary depending on the conductive properties of the soil, i.e., where the frame may act as a ground to earth connection. It shall be appreciated that the metallic components described herein is not intended to limit the disclosure, and that the components may be made of various conductive material(s) known in the art for achieving a properly conductive lightning protection system. It shall be appreciated that the air terminal system described herein may be changed according to time, place, and intended duration of protection. For example, a wire system connecting the air terminals can be added or a safety tip or additional needles may be added to the air terminals; a grounding plate can replace the earth rods if necessary, for certain types of soil or rock formations; the couplers may be replaced by additional clamps with wider spaces for the connecting rods, etc. In some embodiments, particularly if swaying of the frame is not an issue, it may be possible to use grounding lugs and wires/cables to jump the connections from connector block to connector block, instead of connecting the blocks using horizontal rods. In some alternate embodiments, the assembly may include a roof which may be assembled with additional connector blocks and connecting rods that form a top frame, to create a lightning protection full enclosure. In some alternate embodiments, additional connector blocks may be used to provide a connection for additional vertical rods.

The constituent elements of the disclosed device and system listed herein are intended to be exemplary only, and it is not intended that this list be used to limit the device of the present application to just these elements. Persons having ordinary skill in the art relevant to the present disclosure may understand there to be equivalent elements that may be substituted within the present disclosure without changing the essential function or operation of the device. Terms such as ‘approximate,’ ‘approximately,’ ‘about,’ etc., as used herein indicate a deviation of within +/−10%. Relationships between the various elements of the disclosed device as described herein are presented as illustrative examples only, and not intended to limit the scope or nature of the relationships between the various elements. Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

What is claimed is:

1. A lightning protection method, comprising:
constructing a continuously conductive structure at an outdoor area by connecting a plurality of conductive components, the continuously conductive structure comprising:
an above ground structure comprising a bottom frame, and an upwards extension assembly coupled to the bottom frame, and
a grounding assembly coupled to the above ground structure, and extending below ground level,
wherein the continuously conductive structure is configured to protect an object, person, and/or animal from a lightning strike within its area,
wherein the plurality of conductive components are connectable in a weld-free manner, and
wherein the continuously conductive structure is a modular structure configured for disassembly and reassembly.

2. The lightning protection method of claim 1, the plurality of conductive components comprising:
components configured to form the above ground structure comprising a plurality of horizontal rods and/or bottom frame cables, a plurality of connection blocks, and a plurality of vertical rods and/or upwards extension cables,
wherein the connection blocks are configured to form the corners of the bottom frame,
wherein the horizontal rods and/or bottom frame cables are configured to connect to sides of the connection blocks and form the sides of the bottom frame,
wherein the vertical rods and/or upward extension cables are configured to connect to tops of the connection bocks and form the upwards extension assembly; and
components configured to form the grounding assembly comprising a grounding cable, and a grounding element,
the grounding element comprising at least one grounding and/or at least one lightning plate,
wherein the grounding cable is configured to connect the grounding element to the above ground structure.

3. The lightning protection method of claim 2, wherein each connection block comprises a triple connection cube including a first side opening on a first side face of the connection block, a second side opening on a second side face of the connection block, the second side face being adjacent the first side face, and a top opening on a top face of the connection block,
wherein constructing the continuously conductive structure comprises inserting one of the horizontal rods into the first side opening, inserting another of the horizontal rods into the second side, and inserting one of the vertical rods into the top opening.

4. The lightning protection method of claim 3, wherein the first side opening, the second side opening, and the top opening each comprise a hole which extends at least partially through the connection block.

5. The lightning protection method of claim 4, wherein the top opening comprises an internally threaded hole.

6. The lightning protection method of claim 3, the plurality of conductive components further comprising a plurality of clamping members configured to clamp the horizontal rods in place when inserted into the connection block.

7. The lightning protection method of claim 6, wherein the clamping members are further configured to clamp the grounding cable to the bottom frame.

8. The lightning protection method of claim 6, the clamping members each comprising a coupling ring including a threaded hole, and a screw configured to threadably engage through the threaded hole.

9. The lighting protection method of claim 3, the plurality of conductive components further comprising a plurality of horizontal rod couplers configured to couple one horizontal rod to another in line, wherein constructing the continuously conductive structure comprises constructing the bottom frame by attaching a multiple number of horizontal rods to one another via the horizontal rod couples to achieve a desired size of the bottom frame.

10. The lighting protection method of claim 3, the plurality of conductive components further comprising a plurality of vertical rod couplers configured to couple one vertical rod to another in line, wherein constructing the continuously conductive structure comprises attaching a multiple number of vertical rods to one another via the vertical rod couples to achieve a desired height of the above ground structure.
